(19) United States
(12) Patent Application Publication
(10) Pub. No.: US 2011/0209319 A1
(43) Pub. Date: Sep. 1, 2011

(54) PHOTOSENSITIVE COCKPIT WINDSHIELD

(76) Inventor: Scott M. Williams, Columbus, OH (US)

(21) Appl. No.: 13/107,949

(22) Filed: May 15, 2011

Related U.S. Application Data
(62) Division of application No. 10/729,490, filed on Dec. 5, 2003.

(51) Int. Cl. B23P 6/00

(52) U.S. Cl. 29/402.01

(57) ABSTRACT

The present invention 10 discloses a cockpit windshield with photosensitive glass that automatically and instantaneously converts from transparent state to dark state in response to, e.g., lightning strikes 16. The user may disable the photosensitive windshield by means of a power switch 22. In a preferred element of the photosensitive windshield, a variable control module 20 can be used to set parameters to suit each application and to accommodate user preference. In addition to a power switch 20 that enables and disables the photosensitive circuit, the control module provides means for the user to set shade capacity (opacity in dark state) 24, response rate 26 and light sensitivity 28. The control module 20 and windshield 12 are interconnected by means of a wire harness 32 or wireless transmitter/receiver. The system is powered by an external AC or DC power source 34. In another preferred element, the photosensitive control system provides means to control and protect multiple windows 36.

### BACKGROUND OF THE INVENTION

### Field of the Invention

The present invention relates generally to a windshield, more specifically, to a cockpit windshield with photosensitive glass that automatically and instantaneously converts from transparent state to dark state.

Lightning strikes and sun glare have created hazards for pilots, navigators, and drivers alike. The flash of intense light from a lighting bolt can hinder the vision or even blind a person, and thus subjecting the pilot and passengers to uncompromising danger.

The photosensitive windshield of the present invention provides means for protection against such hazards associated with lightning strikes and sun glare by instantaneously changing from a transparent state to a dark state.

The transformation from transparent to dark is achieved by a lamination of different layers including polarizers, liquid crystal elements and a cover glass. The liquid crystal elements act as shutters that detect and react to the light intensity by instantly shading the windshield.

When the lightning strike conditions cease, the photosensitive windshield instantaneously changes back from the dark state to the transparent state. Additionally, the pilot (user) may disable the photosensitive windshield by means of a power switch. When the switch is in an “off” position, the photosensitive windshield remains in a transparent state in any condition.

In a preferred element of the present invention, photosensitive windshield includes a variable control module that can be used to set parameters to suit each application and to accommodate user preference.

In addition to a power switch that enables and disables the photosensitive circuit, the control module provides means for the pilot (user) to set shade capacity (opacity in dark state), response rate, and light sensitivity.

The control module and windshield are interconnected by means of a wire harness or wireless transmitter/receiver. The system is powered by an external AC or DC power source.

In another preferred element, the photosensitive control system provides mean to control and protect multiple windows. By utilizing additional photosensitive windows in other areas such as the cabin of the aircraft, the safety and comfort of passengers and other crewmembers is enhanced.

The control module includes means to set independent settings for two or more photosensitive windows.

In addition to the photosensitive controls, the cockpit windshield of the present invention may include other controls and features typical of existing windshields. Typical of which includes heating elements for de-icing.

Furthermore, in addition to the improved safety of general aviation, the photosensitive window system of the present invention may be utilized to protect other transportation means, such as locomotives, nautical vessels, and automobiles. As well as building structures or any other device that subjects the user or occupant to hazards of intense light.

In still yet another preferred element of the present invention, an embodiment of the present invention provides means for adding a photosensitive shield to an existing windshield. The retrofitted photosensitive shield is fixedly attached to the exterior of the existing shield and frame providing improved cost effectiveness to after market applications.

### Description of the Prior Art

There are other mechanisms and means devised to shield or reduce light through a windowpane. Typical of these is U.S. Pat. No. 2,423,322 issued to S. C. Hurley, Jr. on Jul. 1, 1947.

A patent was issued on Aug. 19, 1952 as U.S. Pat. No. 2,607,906 to V.S. Sang. Another patent was issued to J. D. Ryan on Apr. 28, 1953 as U.S. Pat. No. 2,636,420. Yet another U.S. Pat. No. 3,400,972 was issued to R. D. McIntyre on Sep. 10, 1968 and still yet another was issued on Apr. 22, 1969 to Howard Christensen as U.S. Pat. No. DP 739,939.

U.S. Pat. No. 5,115,341 was issued to William H. Bentley on May 19, 1992. Another patent was issued to William H. Bentley on Sep. 28, 1993 as U.S. Pat. No. 5,249,078. Yet another U.S. Pat. No. 5,270,518 was issued to Yves Naoumenko on Dec. 14, 1993 and still yet another was issued to Ralph Speelman on Dec. 21, 1993 as U.S. Pat. No. 5,271,580.

Another patent was issued to Ernest R. Love on Mar. 25, 2003 as U.S. Pat. No. 6,536,828 and WO Patent No. 00/20915 was issued on Apr. 13, 2000 to Abraham L. Berlad.

### U.S. Pat. No. 2,423,322

### Inventor: S. C. Hurley, Jr.

### Issued: Jul. 1, 1947

It is an object of this invention to provide a means for controlling and regulating the amount of light reaching the occupants of an automobile, truck or the like and at the same time, control and regulate the amount of light emitted by the headlights of a car so equipped.

### U.S. Pat. No. 2,607,906

### Inventor: V. S. Sang

### Issued: Aug. 19, 1952

The primary object of my invention is the provision of means whereby such, automatic controlled glare shields may be manually placed or retained in operative position, either when said light circuits are, on or off.

### U.S. Pat. No. 2,636,420

### Inventor: J. D. Ryan

### Issued: Apr. 28, 1953

The present invention relates generally to glare screens, and more particularly to a novel type of laminated safety glass window, windshield or the “like that is provided with a built-in glare reducing, portion.

Briefly stated, this invention contemplates a laminated safety glass unit which includes a non-brittle plastic interlayer having a colored or neutral shaded glare-reducing portion which is preferably of a shade graduated from deep or opaque at one side of its area to practical extinction at another, laminated with one or more sheets of glass which have a relatively high luminous transmittance in the visible region of the spectrum, but have relatively low ultra-violet light transmittance.

### U.S. Pat. No. 3,400,972

### Inventor: R. D. McIntyre

### Issued: Sep. 10, 1968

A vehicle windshield having its upper portion coated with alight sensitive photochromic material. A light grating, coextensive with the photochromic material and located exteriorly of the latter, allows forward visibility to a predetermined extent and allows only rays of the sun that would blind the eyes of the vehicle operator or front seat passenger to impinge upon the photochromic material.

### U.S. Pat. No. DP 739,939

### Inventor: H. V. Christensen

### Issued: Apr. 22, 1969

In order to correct double vision characteristics of curved windshields constructed of, two sheets of glass, each sheet having a uniform thickness, a tapered or wedged vinyl inner layer is positioned therebetween during a laminating operation. The vinyl inner layer is thicker at the top of the windshield than at the bottom. In a preferred windshield construction, the inner layer had a thickness of 0.035 inch at the top and 0.015 inch at the bottom of the windshield which was 26 inches wide. The amount of wedge to be placed in the layer of vinyl depends both on the .angle of installation of the windshield and the radius of curvature of the windshield. These factors are correlated graphically for windshields having different radius of curvature. The graphical illustration shows that for a 60-inch curvature a wedge angle of three to five minutes is sufficient to eliminate the double vision characteristics whereas a wedge angle of one to three minutes is sufficient to eliminate double vision characteristics for a 150-inch radius of curvature windshield.

### U.S. Pat. No. 5,115,341

### Inventor: William H. Bentley

### Issued: May 19, 1992

A sun visor device for use in the cockpit of aircraft, comprising an optically active visor movably mounted in operable relationship with the windshield in said cockpit. The visor is polarized in the vertical plane and a polarized disk is movably mounted on the visor to permit both linear movement for positioning the disk and rotational movement for relative rotation between the vertical and horizontal polarization positions.

### U.S. Pat. No. 5,249,078

### Inventor: William H. Bentley

### Issued: Sep. 28, 1993

A sun visor device for use in the cockpit of aircraft, comprising an optically active visor movably mounted in operable relationship with the windshield in the cockpit. The visor is polarized in the vertical plane and has a pair of polarized disks movably mounted on the visor to permit rotational movement for relative rotation between the vertical and horizontal polarization positions.

### U.S. Pat. No. 5,270,518

### Inventor: Yves Naoumenko

### Issued: Dec. 14, 1993

This invention relates to a laminated glazing pane which may be used as an aircraft windshield. The pane comprises at least two glass sheets connected together by an intermediate layer of polyvinyl butyral and, in its marginal zone, between at least one glass sheet and the intermediate layer, at least one adhesive ring comprising a plastic material which absorbs at least a portion of the stresses to which the pane is subjected during operation.

### U.S. Pat. No. 5,271,580

### Inventor: Ralph Speelman

### Issued: Dec. 21, 1993

An aircrew controllable sunlight filter for preventing sunlight washout of aircraft instruments comprises as part of an otherwise conventional laminated aircraft transparency an additional ply or layer of photosensitive material positioned near the inside of the transparency. An ultraviolet light source aimed by an aircrew member at a part area of the transparency will cause the transparency to darken and reduce the amount of visible sunlight striking the aircraft instruments.

### U.S. Pat. No. 6,536,828

### Inventor: Ernest R. Love

### Issued: Mar. 25, 2003

A vehicle solar windshield system comprising a front windshield composed of a first transition lens material, at least one side window composed of a second transition lens material and a rear windshield composed of a third transition lens material. In one embodiment, the first transition lens material has a first darkening strength, the second lens material has a second darkening strength which is greater than the first darkening strength and the third lens material has a third darkening strength which is greater than the second darkening strength. In a preferred embodiment, the transitional lens material is a photochromic lens material.

### WO Patent Number 00/20915

### Inventor: Abraham L. Berlad

### Issued: May 2, 2000

A method and apparatus for reducing glare created by oncoming headlights or the sun at either dusk or dawn is disclosed. The method uses a light filter to reduce the intensity of light encountered by a driver from oncoming headlights in a region. The region is defined by the driver's side portion of the windshield and a separatrix. The separatrix includes a horizontal segment, a vertical segment, and a perspective segment. The horizontal segment is located between the driver's side portion and the passenger's side portion of the perimeter of the windshield. The horizontal segment has first and second ends such that the second end is adjacent to the driver's side portion and the first end is adjacent to the passenger's side portion. The vertical segment begins at a central position on the upper portion of the windshield and ends at the first end of the horizontal segment. The perspective segment begins at the second end of the horizontal segment and extends downward at an obtuse angle towards the driver's side portion of the windshield ending at the lower portion of the windshield. The perspective segment accounts for the approach pattern of automobiles and terminates at the horizontal segment which is preferably substantially parallel with the horizon.

The light filter uses either tinted elements, polarized elements, or a combination of both tinted and polarized elements for reducing the intensity of the light. Various embodiments of the apparatus disclosed herein include eyeglasses, clip-on eyeware, windshields, visors, and a combination of either eyeglasses or clip-on eyeware to be combined with either a windshield or visor.

While these mechanisms and means devised to shield or reduce light through a windowpane may be suitable for the purposes for which they were designed, they would not be as suitable for the purposes of the present invention, as hereinafter described.

### SUMMARY OF THE PRESENT INVENTION

The present invention discloses a cockpit windshield with photosensitive glass that automatically and instantaneously converts from transparent state to dark state in response to, e.g., lightning strikes. The user may disable the photosensitive windshield by means of a power switch. In a preferred element of the photosensitive windshield, a variable control module can be used to set parameters to suit each application and to accommodate user preference. In addition to a power switch that enables and disables the photosensitive circuit, the control module provides means for the user to set shade capacity (opacity in dark state), response rate and light sensitivity. The control module and windshield are interconnected by means of a wire harness or wireless transmitter/receiver. The system is powered by an external AC or DC power source. In another preferred element, the photosensitive control system provides means to control and protect multiple windows.

A primary object of the present invention is to provide a cockpit windshield with photosensitive glass that automatically and instantaneously converts from transparent state to dark state.

Another object of the present invention is to provide a cockpit windshield with photosensitive glass that automatically and instantaneously converts from transparent state to dark state when a certain light intensity level exists.

Still another object of the present invention is to provide a cockpit windshield with photosensitive glass that automatically and instantaneously converts from dark state to transparent state when safe level of light intensity is reached.

Yet another object of the present invention is to provide a cockpit windshield with photosensitive glass that includes a control module that provides means to enable or disable the photosensitive circuit.

Still another object of the present invention is to provide a cockpit windshield with photosensitive glass that includes a control module that provides means to set the shade or level of opacity when in the dark state.

Another object of the present invention is to provide a cockpit windshield with photosensitive glass that includes a control module that provides means to set the speed in which the windshield converts from one state to another.

Yet another object of the present invention is to provide a cockpit windshield with photosensitive glass that includes a control module that provides means to set the light sensitivity or amount of light needed to change states.

Still another object of the present invention is to provide a cockpit windshield with photosensitive glass that includes a control module that provides means to control multiple photosensitive windows.

Additional objects of the present invention will appear as the description proceeds.

The present invention overcomes the shortcomings of the prior art by providing an improved means to protect the pilot (user) from hazards of intense light level conditions caused by lightning strikes and sun glare.

The foregoing and other objects and advantages will appear from the description to follow. In the description reference is made to the accompanying drawings, which form a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

### BRIEF DESCRIPTION OF THE DRAWINGS

In order that the invention may be more fully understood, it will now be described, by way of example, with reference to the accompanying drawings in which:

FIG. 1 is an illustrative view of a cockpit windshield of the prior art.

FIG. 2 is an illustrative view of a cockpit windshield of the present invention.

FIG. 3 is a perspective view of a cockpit windshield of the present invention in use.

FIG. 4 is a perspective view of a cockpit windshield of the present invention in an inactive state.

FIG. 5 is a flow chart of the cockpit windshield's operative mode.

FIG. 6 is a block diagram of the photosensitive windshield control module.

FIG. 7 is an interconnection diagram of the cockpit windshield of the present invention.

FIG. 8 is a perspective view of a cockpit windshield of the present invention in use.

FIG. 9 is a block diagram of the photosensitive windshield control module for use with multiple windows.

FIG. 10 is an interconnection diagram of the cockpit windshield of the present invention.

FIG. 11 is a block diagram of various applications of the photosensitive controlled windows.

FIG. 12 is an illustrative view of a preferred embodiment of the photosensitive controlled windows.

### LIST OF REFERENCE NUMERALS

With regard to reference numerals used, the following numbering is used throughout the drawings.
10 present invention
12 prior art windshield
14 airplane
16 lightning strike
18 rain
20 control module
22 power switch
24 shade control
26 response rate control
28 sensitivity control
30 photosensitive area
32 wiring
34 power source
36 windows
38 shield
40 airframe

### DETAILED DESCRIPTION OF THE PREFERRED EMBODIMENTS

The following discussion describes in detail one embodiment of the invention and several variations of that embodiment. This discussion should not be construed, however, as limiting the invention to those particular embodiments since practitioners skilled in the art will recognize numerous other embodiments as well. For a definition of the complete scope of the invention, the reader is directed to the appended claims.

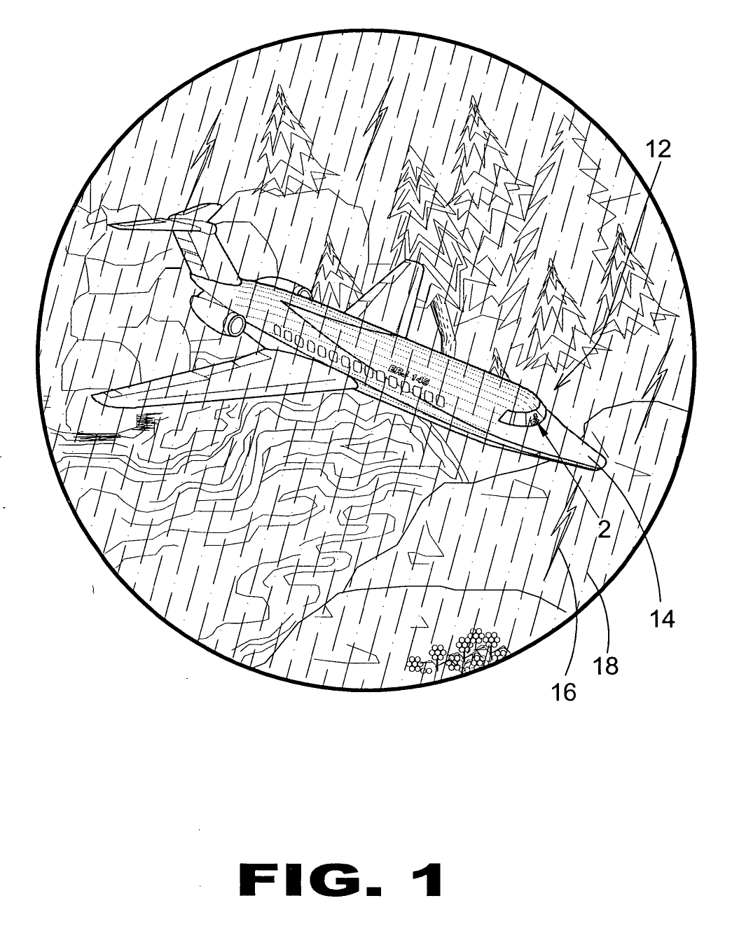

Turning to FIG. 1, shown therein is an illustrative view of a cockpit windshield 12 of a prior art airplane 14. Depicted is a shortcoming of a cockpit windshield 12 of the prior art. Hazards are created when the pilot of an aircraft 14 is subject to common weather conditions. Conditions that include sun glare or more severe lightning strikes 16 in rain 18 that can impair or potentially blind the pilot.

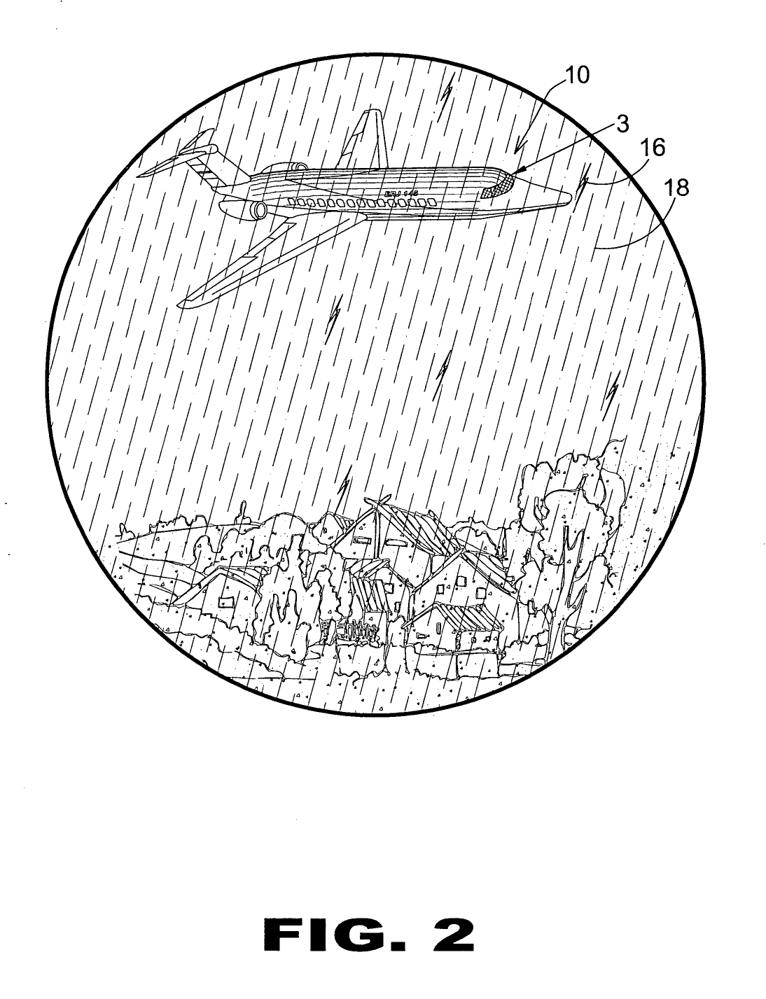

Turning to FIG. 2, shown therein is an illustrative view of a cockpit windshield of the present invention 10. Shown is the photosensitive windshield of the present invention 10 that instantaneously changes from a transparent state to a dark state depending on the intensity of illumination whereby the pilot is protected from the hazards of sun glare, lightning strike 16 and/or rain 18 conditions.

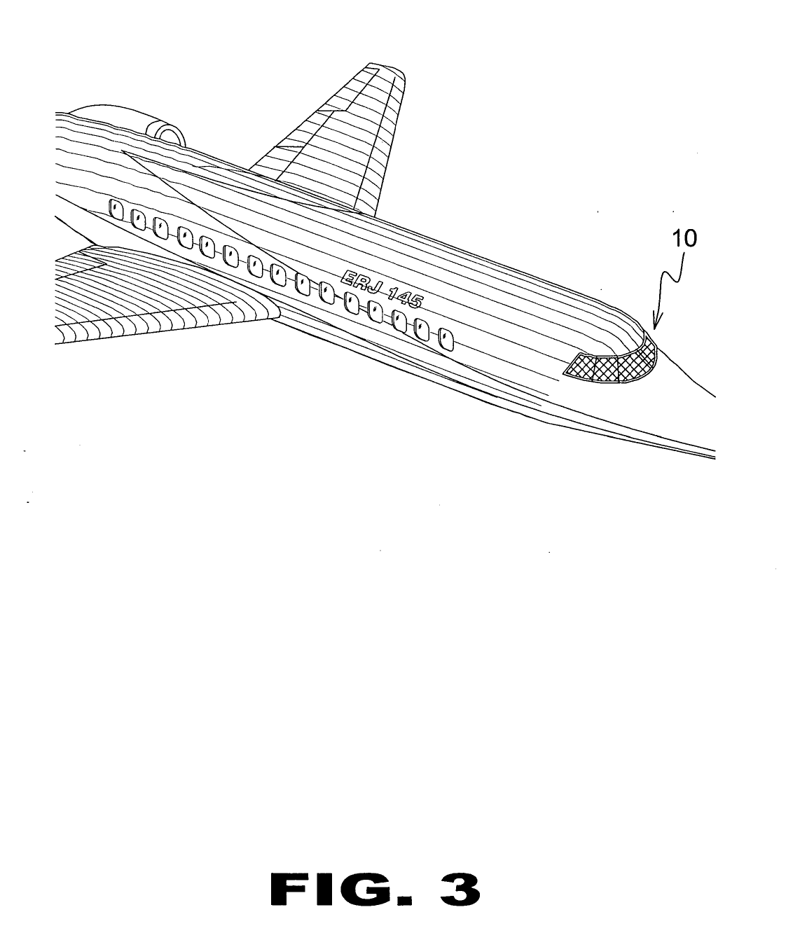

Turning to FIG. 3, shown therein is a perspective view of a cockpit windshield of the present invention 10 in use. Depicted is the photosensitive windshield of the present invention 10 in a dark state. The instantaneous change from a transparent state to a dark state is achieved by a lamination of different layers including polarizers, liquid crystal elements and a cover glass. The liquid crystal elements act as shutters that detect and react to the light intensity by instantly shading the windshield 10.

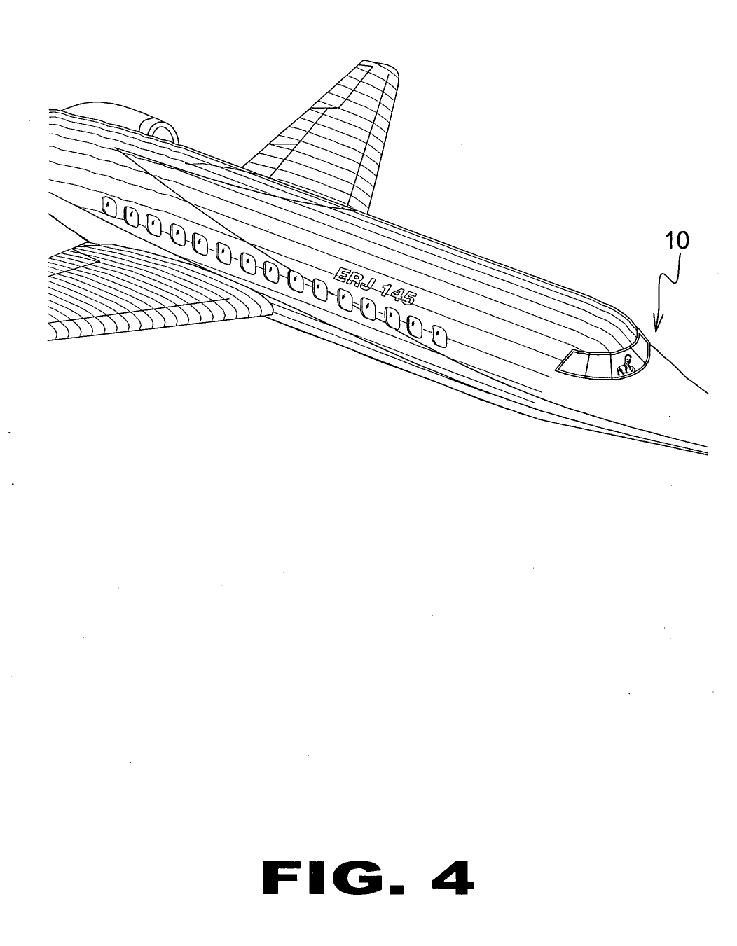

Turning to FIG. 4, shown therein is a perspective view of a cockpit windshield of the present invention 10 in an inactive state. Shown is the photosensitive windshield of the present invention 10 in a transparent state. When the lightning strike conditions cease, the photosensitive windshield 10 instantaneously changes back from the dark state to the transparent state. Additionally, the user may disable the photosensitive windshield 10 by means of a power switch. When the switch is in an “off” position, the photosensitive windshield 10 remains in a transparent state in any condition.

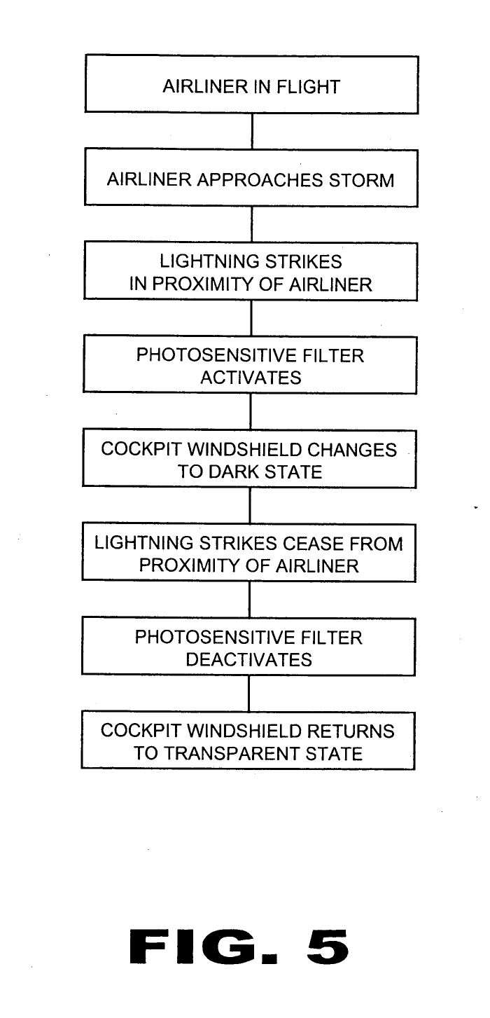

Turning to FIG. 5, shown therein is a flow chart of the cockpit windshield 10 in operative mode. Illustrated is a sequence of events that will cause the photosensitive filter within the cockpit window to block intense light that can be harmful to the cockpit crew. The steps of operation include: (1) airliner is in flight; (2) airliner approaches storm; (3) lightning strikes occur in proximity of airliner; (4) photosensitive filter activates; (5) cockpit windshield 10 changes to dark state; (6) lightning strikes cease from proximity of airliner; (7) photosensitive filter deactivates; and (8) cockpit windshield 10 returns to transparent state.

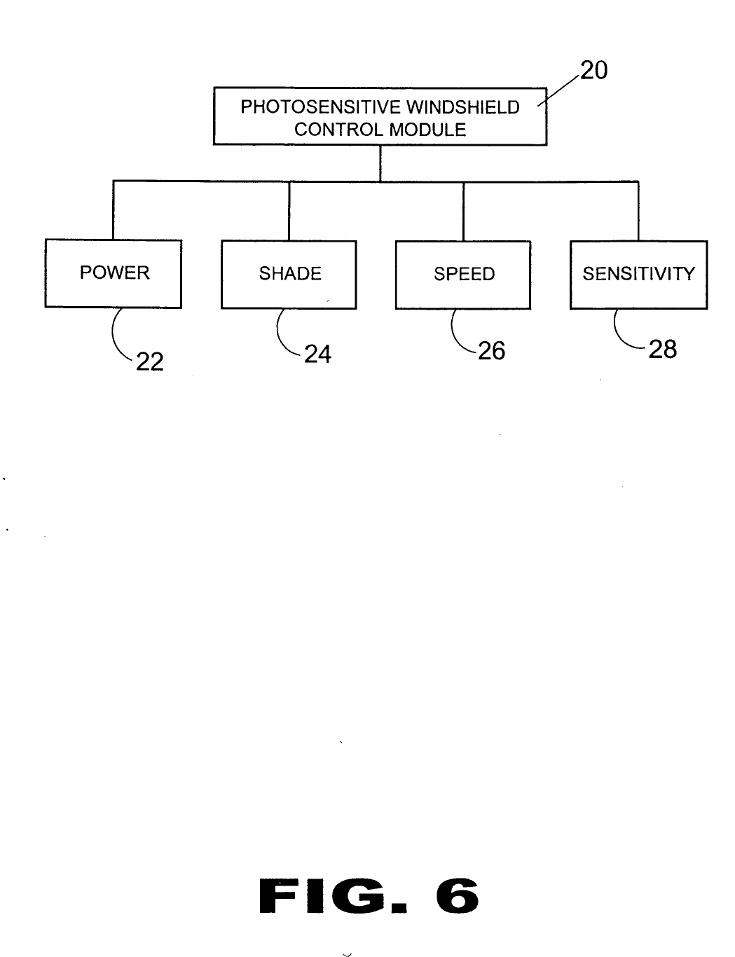

Turning to FIG. 6, shown therein is a block diagram of the photosensitive windshield control module 20. Illustrated is the present invention's photosensitive windshield variable control module 20 that can be used to vary parameters to suit each application and to accommodate user preferences. The photosensitive windshield of the present invention includes a control module 20 that allows the user to enable or disable the photosensitive circuit at 22, adjust shade capacity (opacity in dark state) at 24, adjust response rate at 26, and adjust light sensitivity at 28.

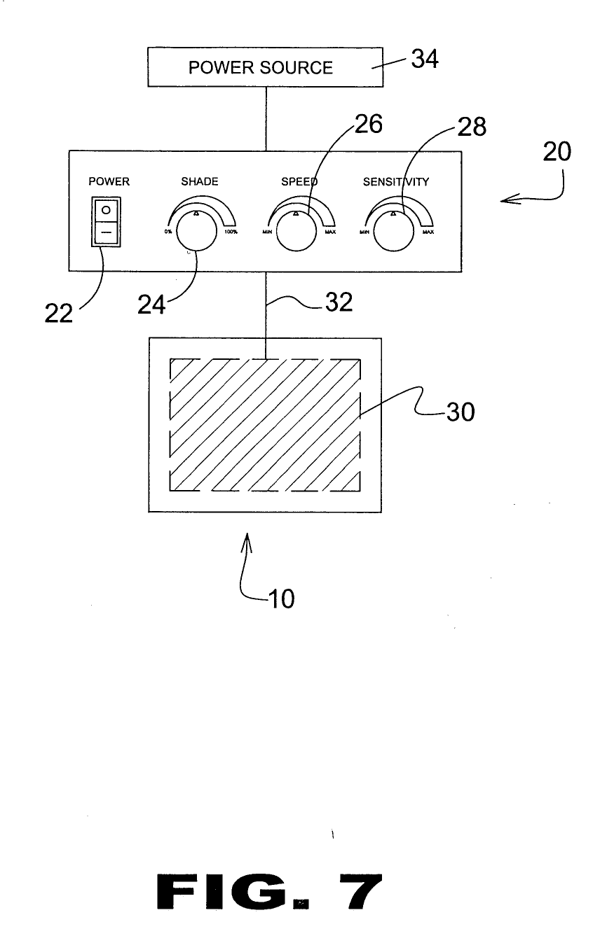

Turning to FIG. 7, shown therein is an interconnection diagram of the cockpit windshield 12 of the present invention. Depicted is the photosensitive area 30 of the windshield system of the present invention 10. The control module 20 and windshield 10 are interconnected by means of a wire harness 32 or wireless transmitter/receiver. The system is powered by an external ac or dc power source 34. Shown are the power switch 22, shade control 24, response rate control 26 and sensitivity control 28.

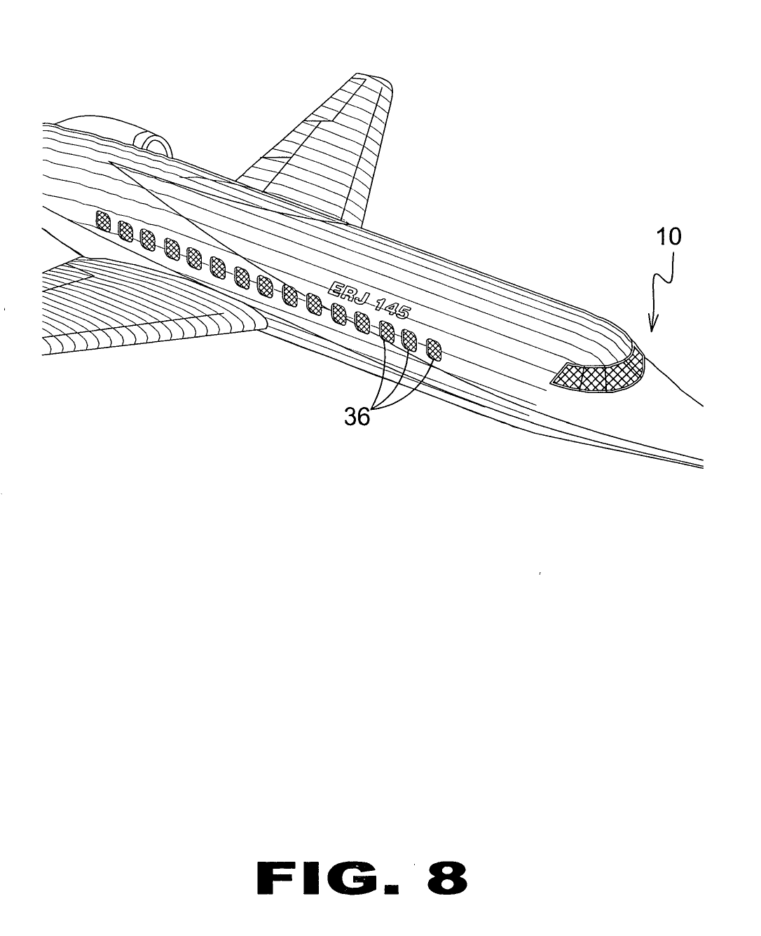

Turning to FIG. 8, shown therein is a perspective view of a cockpit windshield 10 of the present invention in use. In a preferred additional element, shown is the photosensitive windshield system of the present invention 10 being utilized on a plurality of windows 36.

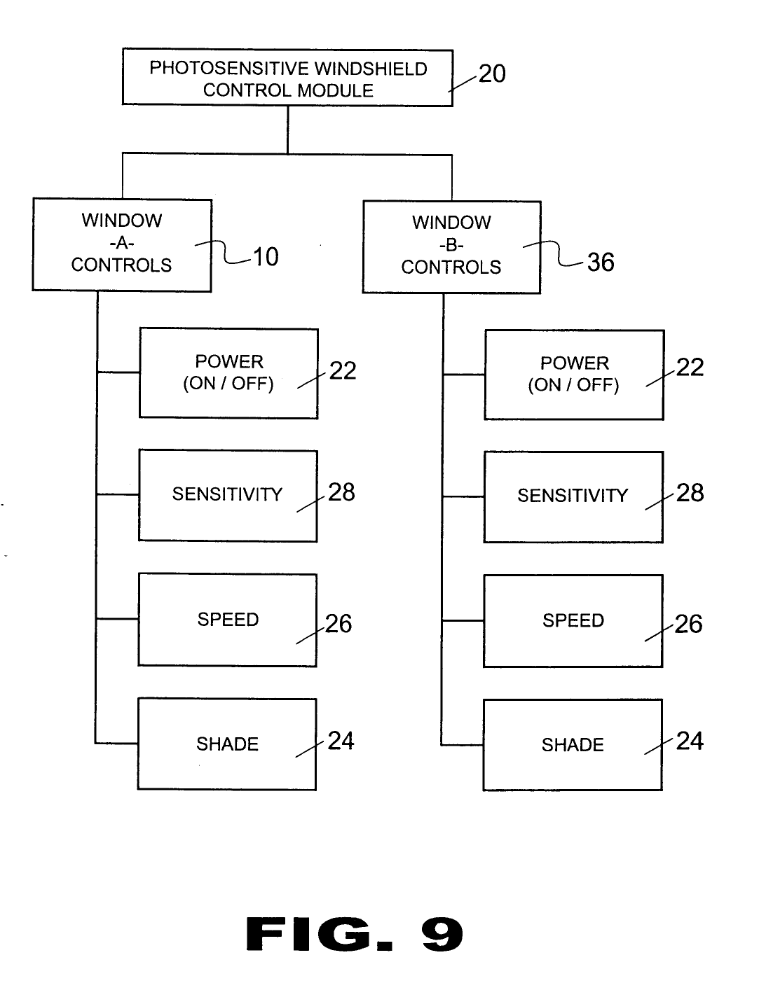

Turning to FIG. 9, shown therein is a block diagram of the photosensitive windshield control module 20 for use with multiple windows. In a preferred additional element, illustrated is the present invention's photosensitive windshield system 10 being utilized on multiple windows 36. The control module 20 includes means to set independent settings for two or more photosensitive windows 10, 36. Also shown are the power switch 22, shade control 24, response rate control 26 and sensitivity control 28.

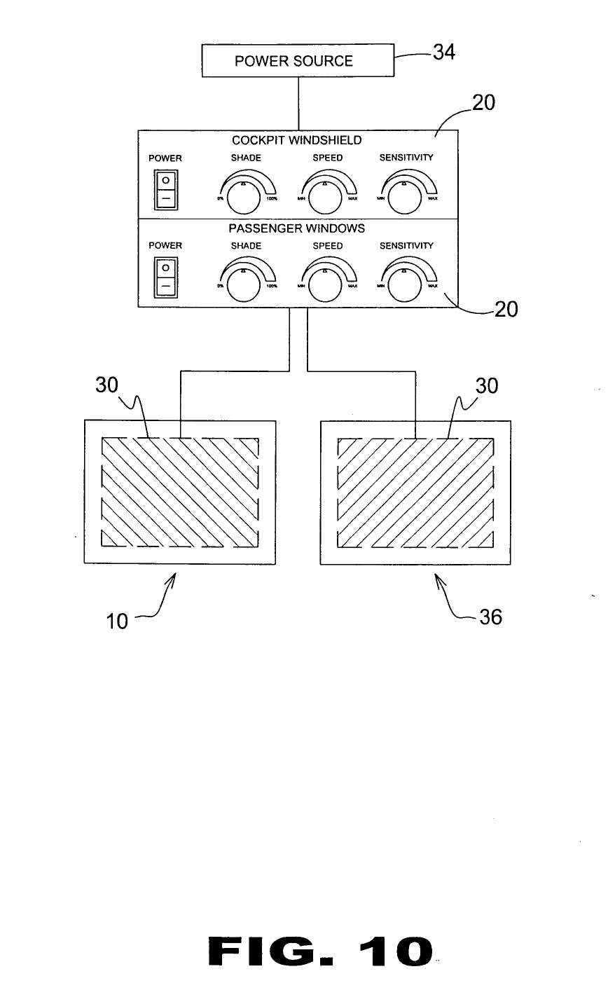

Turning to FIG. 10, shown therein is an interconnection diagram of the cockpit windshield of the present invention. FIG. 10 depicts the present invention's photosensitive windshield system being utilized on multiple windows 10, 36. By utilizing additional photosensitive windows 36 in other areas of the aircraft, the safety and comfort of passengers and other crewmembers is enhanced. Shown are a power source 34, a pair of control modules 20, cockpit windshield 10 and passenger window 36 with photosensitive areas 30.

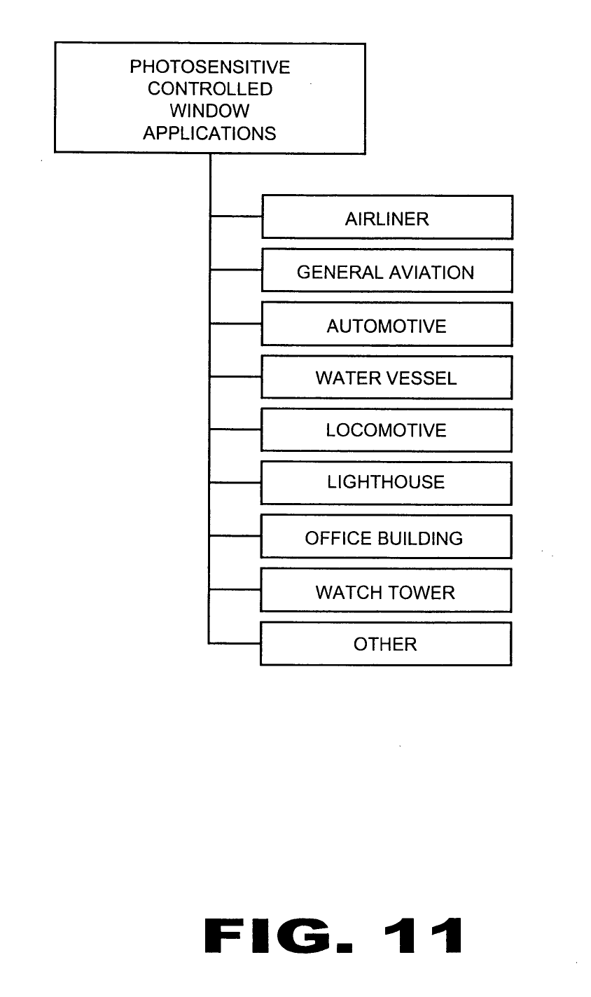

Turning to FIG. 11, shown therein is a block diagram of various applications of the photosensitive controlled windows. In addition to the improved safety of air transportation, the photosensitive window system of the present invention may be utilized to protect other transportation means, building structures, or any other device that subjects the user or occupant to hazards of intense light including, but not necessarily limited to: airliner, general aviation, automotive, water vessel, locomotive, lighthouse, office building, and watch tower.

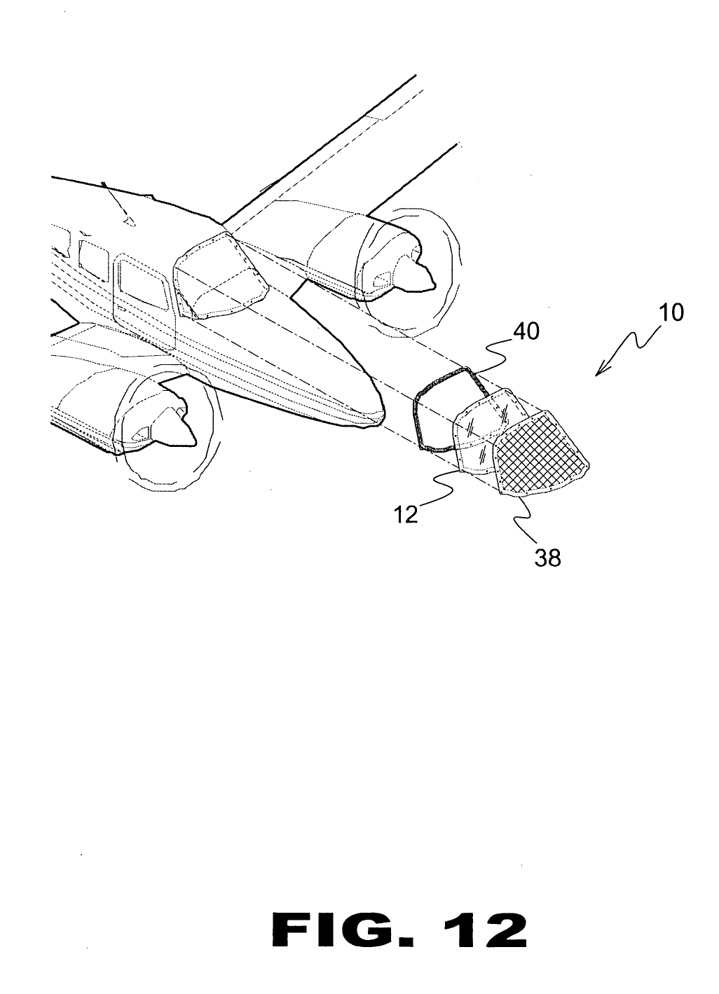

Turning to FIG. 12, shown therein is an illustrative view of a preferred embodiment of the photosensitive controlled windows. To suit after market applications, a preferred embodiment of the present invention 10 provides means for adding a photosensitive window or shield 38 to the existing windshield 12. The retrofitted photosensitive shield 38 is fixedly attached to the exterior of the existing windshield 12 and airframe 40.

1-18. (canceled)

19. A method for retrofitting a cockpit windshield of an airplane, comprising the steps of:
providing an airplane with a windshield that is not photosensitive;
providing a window with a photosensitive portion which automatically changes from a transparent state to a darker state in response to varying light conditions;
providing a photosensitive circuit for controlling said photosensitive portion;
providing a control unit for controlling said photosensitive circuit, said control unit having an opacity control for controlling opacity and a control for controlling a light sensitivity of said photosensitive portion;
securing said window over an exterior surface of said windshield; and,
adjusting the light sensitivity of said photosensitive window via said light sensitivity control of said control unit.

20. The method for retrofitting a cockpit windshield of an airplane according to claim 19, wherein at least a portion of said window surrounding said photo-sensitive portion is transparent.
